(19) United States
(12) Patent Application Publication
(10) Pub. No.: US 2014/0288916 A1
(43) Pub. Date: Sep. 25, 2014

(54) METHOD AND APPARATUS FOR FUNCTION CONTROL BASED ON SPEECH RECOGNITION

(71) Applicant: Samsung Electronics Co., Ltd., Gyeonggi-do (KR)

(72) Inventors: Howon JUNG, Gyeonggi-do (KR); Youngdae KOO, Seoul (KR); Taehyung KIM, Gyeonggi-do (KR)

(73) Assignee: Samsung Electronics Co., Ltd., Gyeonggi-do (KR)

(21) Appl. No.: 14/224,617

(22) Filed: Mar. 25, 2014

(30) Foreign Application Priority Data
Mar. 25, 2013 (KR) 10-2013-0031472

(51) Int. Cl. G10L 15/00; G06F 17/28; G10L 15/26

(52) U.S. Cl. CPC G10L 15/00; G10L 15/26; G06F 17/28
USPC 704/2

(57) ABSTRACT

Methods and apparatus are provided for controlling a function based on speech recognition. Speech input in a first language is recognized. Dictation, which converts the speech input into text based on the first language, is performed. A language change event is detected. Additional speech input in a second language, which is different from the first language, is recognized after the language change event. Dictation, which converts the additional speech input into additional text based on the second language, is performed.

### PRIORITY

This application claims priority under 35 U.S.C. §119(a) to a Korean patent application filed on Mar. 25, 2013 in the Korean Intellectual Property Office and assigned Ser. No. 10-2013-0031472, the entire disclosure of which is incorporated herein by reference.

### BACKGROUND

1. Field of the Invention

The present invention relates generally to functions of a mobile device, and more particularly, to a method and apparatus for a function control based on speech recognition.

2. Description of the Related Art

With the growth of digital technologies, a variety of mobile devices, such as, for example, Personal Digital Assistants (PDAs), electronic organizers, smart phones, and tablet Personal Computers (PCs), which enable communication and data processing in mobile environments, have become increasingly popular. Such mobile devices have outgrown their respective traditional fields and have reached a stage of convergence. For example, these mobile devices can offer functions or applications, such as a voice/video call, a messaging service such as, for example, Short Message Service (SMS), Multimedia Message Service (MMS), or email, a navigation service, a digital camera, an electronic dictionary, an electronic organizer, a broadcast receiving service, a media file playback, Internet access, a messenger service, and a Social Networking Service (SNS).

Various techniques for recording events of personal life as digital information have been developed, which contribute to the growth of a context awareness service.

Normally, a context awareness service determines the content of a service and whether to provide a service, depending on a variation in context defined by a service object (e.g., a user). Context refers to information used to determine a particular service action defined by a service object and may include a time to provide a service, whether to provide a service, a target for a service, a location to provide a service, and the like.

A typical method for entering a sentence using speech recognition in a smart input device includes recognizing a language and taking dictation of the recognized language. However, dictation of a certain sentence in which the English language and the Korean language are mixed may result in incorrect recognition, which differs from the user's intention. In order to prevent this drawback, a user must separately select language types required for dictation.

### SUMMARY

The present invention has been made to address at least the above problems and/or disadvantages and to provide at least the advantages described below. Accordingly, an aspect of the present invention provides a method and apparatus the enables an easy change of a language type in dictation of a sentence using speech recognition.

According to one aspect of the present invention, a method is provided for controlling a function based on speech recognition. Speech input in a first language is recognized. Dictation, which converts the speech input into text based on the first language, is performed. A language change event is detected. Additional speech input in a second language, which is different from the first language, is recognized after the language change event. Dictation, which converts the additional speech input into additional text based on the second language, is performed.

According to another aspect of the present invention, an apparatus is provided for controlling a function based on speech recognition. The apparatus includes a speech input unit configured to recognize speech input, and to recognize additional speech input after a language change event for changing from a first language to a second language, which is different from the first language. The apparatus also includes a control unit configured to perform dictation, which converts the speech input into text based on the first language, and to perform dictation, which converts the additional speech input into additional text based on the second language. The apparatus further includes a display unit configured to display the text based on the first language and to display the additional text based on the second language.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a block diagram illustrating an electronic device, in accordance with an embodiment of the present invention;

FIGS. 2 to 4 are diagrams illustrating a function of dictation based on speech recognition, in accordance with an embodiment of the present invention;

FIG. 5 is a flow diagram illustrating a method for controlling a function of dictation based on speech recognition, in accordance with an embodiment of the present invention;

FIG. 6 is a flow diagram illustrating a method for controlling a function of dictation based on speech recognition, in accordance with another embodiment of the present invention; and

FIG. 7 is a flow diagram illustrating a method for controlling a function of dictation based on speech recognition, in accordance with another embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

The terms and words used in the following description and claims are not limited to their dictionary meanings, but are merely used by the inventor to enable a clear and consistent understanding of the present invention. Accordingly, it should be apparent to those skilled in the art that the following description of various embodiments of the present invention is provided for illustrative purposes only, and not for the purpose of limiting the present invention as defined by the appended claims and their equivalents.

It is to be understood that the singular forms “a,” “an,” and “the” include plural referents unless the context clearly dictates otherwise. Thus, for example, reference to “an event” includes reference to one or more of such events.

According to an embodiment of the present invention, an electronic device controls a function based on speech recognition and also performs an overall operation associated with a service based on speech recognition. Such an electronic device may be any kind of electronic device which employs an Application Processor (AP), a Graphic Processing Unit (GPU), and/or a Central Processing Unit (CPU). For example, an electronic device may be one of various types of mobile communication terminals, such as, for example, a tablet PC, a smart phone, a digital camera, a Portable Multimedia Player (PMP), a media player, a portable game console, a PDA, and the like. Additionally, a function control method of an embodiment of the present invention may be favorably applied to various types of display devices such as, for example, a digital Television (TV), Digital Signage (DS), a Large Format Display (LFD), and the like.

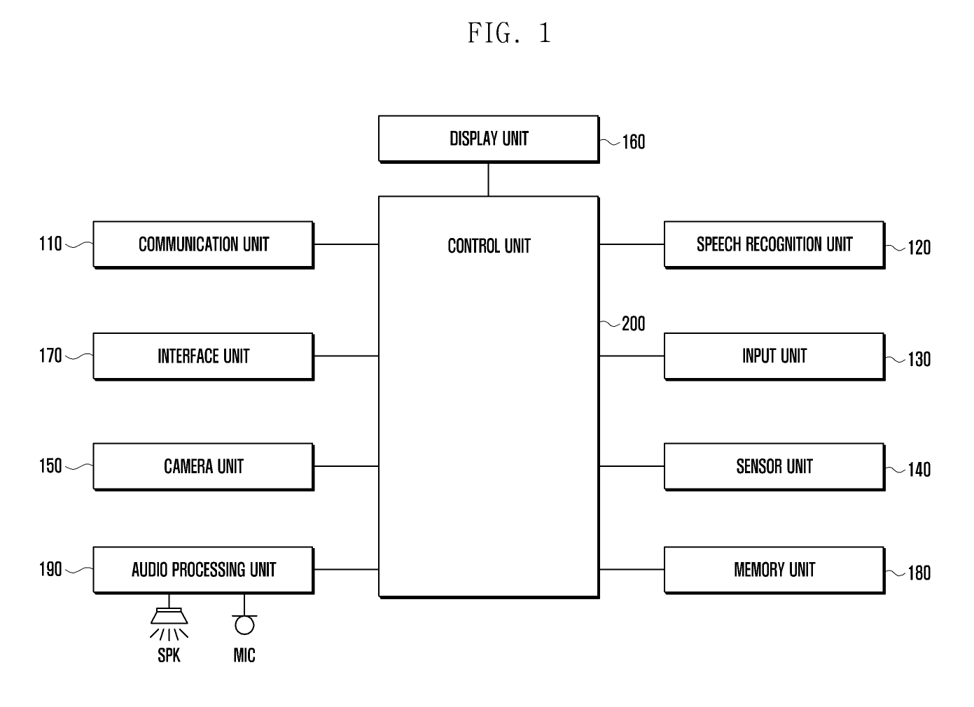

FIG. 1 is a block diagram illustrating an electronic device, in accordance with an embodiment of the present invention.

Referring to FIG. 1, the electronic device includes a wireless communication unit 110, a speech recognition unit 120, an input unit 130, a sensor unit 140, a camera unit 150, a display unit 160, an interface unit 170, a memory unit 180, an audio processing unit 190, and a control unit 200. These elements of the electronic device may not always be essential. Alternatively, more or less elements may be included in the electronic device.

The wireless communication unit 110 may have one or more modules capable of performing wireless communication between the electronic device and a wireless communication system, or between the electronic device and any other electronic device. For example, the wireless communication unit 110 may have at least one of a mobile communication module, a Wireless Local Area Network (WLAN) module, a short-range communication module, a location computing module, and a broadcast receiving module.

The mobile communication module may transmit or receive a wireless signal to or from at least one of a base station, an external device, and a server in a mobile communication network. A wireless signal may include a voice call signal, a video call signal, and text/multimedia message data. The mobile communication module may perform access to an operator server or a contents server under the control of the control unit 200, and then download a language table in which various user events for executing a dictation function based on speech recognition and actions thereof are mapped with each other.

The WLAN module refers to a module for performing a wireless Internet access and establishing a wireless LAN link with one or more other electronic devices. The WLAN module may be embedded in or attached to the electronic device. For wireless Internet access, a well-known technique, such as, for example, Wireless Fidelity (Wi-Fi), Wireless broadband (Wibro), World interoperability for microwave access (Wimax), or High Speed Downlink Packet Access (HSDPA) may be used. The WLAN module may perform access to an operator server or a contents server under the control of the control unit 200, and then download a language table in which various user events for executing a dictation function based on speech recognition and actions thereof are mapped with each other. Also, when a wireless LAN link is formed with any other electronic device, the WLAN module may transmit to, or receive from, the other electronic device a language table in which user-selected user events and actions thereof are mapped with each other. The WLAN module may transmit or receive a language table to or from a cloud server through a wireless LAN.

The short-range communication module refers to a module designed for a short-range communication. As short-range communication technique, Bluetooth, Radio Frequency Identification (RFID), Infrared Data Association (IrDA), Ultra Wideband (UWB), ZigBee, Near Field Communication (NFC), and the like, may be used. When connected to any other electronic device via short-range communication, the short-range communication module may transmit or receive a language table to or from other electronic device.

The speech recognition unit 120 may perform a speech recognition operation to execute various functions of the electronic device by recognizing speech input. For example, one such function may be a dictation function to change a speech input into a text string and then display the text string on the display unit 160. The speech recognition unit 120 may include a sound recorder, an engine manager, and a speech recognition engine.

The sound recorder may record audio (e.g., user speech, etc.) received from a microphone to create recorded data.

The engine manager may transfer recorded data received from the sound recorder to the speech recognition engine and transfer recognition results received from the speech recognition engine to the control unit 200.

The speech recognition engine may be formed of a particular program that includes a speech-to-text engine for converting a speech input into a text string.

The speech recognition unit 120 may be formed of software, based on an Operating System (OS), to perform an operation associated with the execution of various services using speech. The speech recognition unit 120 formed of software may be stored or loaded in the memory unit 180, the control unit 200, or a separate processor.

The input unit 130 may receive a user's manipulation and create input data for controlling the operation of the electronic device. The input unit 130 may be selectively composed of a keypad, a dome switch, a touchpad, a jog wheel, a jog switch, and the like. The input unit 130 may be formed of buttons installed at the external side of the electronic device, some of which may be realized in a touch panel. The input unit 130 may create input data when a user's input, for setting a language or triggering a dictation function based on language recognition, is received.

The sensor unit 140 may detect a user event occurring in the electronic device and then create a related sensing signal. This sensing signal may be transmitted to the control unit 200. The sensor unit 140 may detect a particular event associated with a specific motion that happens in the electronic device.

For example, the sensor unit 140 may detect a motion event of the electronic device through a motion sensor. This motion event may be induced by a user.

A motion sensor may detect variations of angle, direction, posture, position, motion intensity, and/or velocity in connection with any motion that occurs in the electronic device. This motion sensor may be an acceleration sensor, a gyro sensor, a geomagnetic sensor, an inertial sensor, a tilt sensor, an infrared sensor, and the like. Alternatively or additionally, any other sensor that can detect or recognize a motion or position of a subject may be used for a motion sensor. The sensor unit 140 may further include a blow sensor or the like in addition to the above-discussed motion sensor.

The sensor unit 140 may always be enabled or may be enabled by a user's selection in order to detect a language change event (i.e., a specific user event entered for a change of an language) during the execution of a dictation function based on speech recognition.

The camera unit 150 may be installed at the front face and/or rear face of the electronic device in order to capture an image and transfer the captured image to the control unit 200 and the memory unit 180. The camera unit 150 may include at least one of a normal camera and an infrared camera. Particularly, the camera unit 150 may always be enabled or may be enabled by a user's selection in order to detect a language change event during the execution of a dictation function based on speech recognition.

The display unit 160 may display any information processed in the electronic device. For example, when the electronic device is in a call mode, the display unit 160 may display a screen interface such as a User Interface (UI) or a Graphic UI (GUI) in connection with a call mode. When the electronic device is in a video call mode or a camera mode, the display unit 160 may display a received and/or captured image, UI or GUI. Particularly, the display unit 160 may display various UIs and/or GUIs associated with a dictation function based on speech recognition, such as, for example, a language display screen for representing a text string converted from a speech input, a screen for showing a result (i.e., a language change result) of a language change event entered for a change of an language, and the like. Examples of such screens or interfaces on the display unit 160 are described in greater detail below.

The display unit 160 may be embodied as a Liquid Crystal Display (LCD), a Thin Film Transistor-LCD (TFT-LCD), a Light Emitting Diode (LED), an Organic LED (OLED), an Active Matrix OLED (AMOLED), a flexible display, a bended display, or a 3D display. Parts of such displays may be realized as a transparent display.

In the case of a touch screen, in which the display unit 160 and a touch panel for detecting a touch gesture are formed of a layered structure, the display unit 160 may be used as the input unit. The touch panel may be configured to detect a pressure or a variation in capacitance from a surface thereof or of the display unit 160, and to convert into an electric input signal. Specifically, the touch panel may detect a touch location, area and pressure. If there is any touch input on the touch panel, a corresponding signal may be transferred to a touch controller. Then the touch controller may process a received signal and send corresponding data to the control unit 200. Therefore, the control unit 200 may recognize which spot is touched.

The interface unit 170 may act as a gateway to and from all external devices connected to the electronic device. The interface unit 170 may receive data from any external device (e.g., a headset) or transmit data of the electronic device to such an external device. Also, the interface unit 170 may receive electric power from any external device (e.g., a power supply device) and distribute it to respective elements in the electronic device. The interface unit 170 may include, for example, but is not limited to, a wired/wireless headset port, a charger port, a wired/wireless data port, a memory card port, an audio input/output port, a video input/output port, and a port for connecting any device having an identification module.

The memory unit 180 may store a program for processing and controlling operations of the control unit 200 and temporarily store data (e.g., various types of languages, a language change event, etc.) inputted or to be outputted. The memory unit 180 may also store the frequency of using a particular function (e.g., the frequency of a language change event, the frequency of a dictation function based on speech recognition, etc.), the priority of a particular function, and the like. Further, the memory unit 180 may store vibration and sound data having specific patterns, and to be outputted in response to a touch input on the touch screen.

Particularly, the memory unit 180 may store a table that contains mapping relations among a predefined or user-defined language change event, a predefined or user-defined action (or function) corresponding to a language change event, information about language types for each language change event, a rule for executing a dictation function based on language recognition, and the like.

Additionally, the memory unit 180 may buffer audio received through the microphone during the execution of a dictation function based on language recognition, and store the buffered audio as recorded data under the control of the control unit 200. When the speech recognition unit 120 is formed of software, the memory unit 180 may store such software.

The memory unit 180 may include at least one storage medium such as, for example, a flash memory, a hard disk, a micro-type memory, a card-type memory, a Random Access Memory (RAM), a Static RAM (SRAM), a Read Only Memory (ROM), a Programmable ROM (PROM), an Electrically Erasable PROM (EEPROM), a Magnetic RAM (MRAM), a magnetic disk, an optical disk, and the like. The electronic device may interact with any kind of web storage that performs a storing function of the memory unit 180 on the Internet.

The audio processing unit 190 may transmit, to a speaker, an audio signal received from the control unit 200, and also transmit to the control unit 200 an audio signal such as, for example, speech received from a microphone. Under the control of the control unit 200, the audio processing unit 190 may convert an audio signal into an audible sound and output it to the speaker, and may also convert an audio signal received from the microphone into a digital signal and output it to the control unit 200.

The speaker may output audio data received from the wireless communication unit 110, audio data received from the microphone, or audio data stored in the memory unit 180 in a call mode, a recording mode, a speech recognition mode, a broadcast receiving mode, a camera mode, a context awareness service mode, or the like. The speaker may output a sound signal associated with a particular function (e.g., the feedback of context information, the arrival of an incoming call, the capture of an image, the playback of media content such as music or video) performed in the electronic device.

The microphone may process a received sound signal into electric voice data in a call mode, a recording mode, a speech recognition mode, a camera mode, a context awareness service mode, or the like. In a call mode, the processed voice data may be converted into a suitable form for transmittance to a base station through the mobile communication module. In a dictation function mode based on speech recognition, the processed voice data may be converted into a suitable form for processing in the control unit 200 through the speech recognition unit 120.

The microphone may have various noise removal algorithms for removing noise from a received sound signal. When any user event for executing a dictation function based on speech recognition or changing a language is received, the microphone may create relevant input data and deliver it to the control unit 200.

The control unit 200 may control the overall operation of the electronic device. For example, the control unit 200 may perform a control process associated with a voice call, a data communication, or a video call. Particularly, the control unit 200 may control the overall operation associated with the execution of a dictation function based on speech recognition.

In an embodiment of the present invention, the control unit 200 may control a process of setting a predefined or user-defined user event (i.e., an language change event), a process of performing a particular action in response to a language change event, a process of retrieving a language for a change specified by a language change event, a process of changing a current language to the retrieved language, and a process of executing a dictation function based on the changed language.

Details of the control unit 200 are described in greater detail below with reference to drawings.

Embodiments of the present invention may be realized using software, hardware, and a combination thereof, in any kind of computer-readable recording medium. In the case of hardware, embodiments of the present invention may be realized using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and any other equivalent electronic unit. Embodiments of the present invention may be realized in the control unit 200 alone. In the case of software, embodiments of the present invention may be realized using separate software modules each of which can perform at least one of the functions discussed herein.

According to an embodiment of the present invention, a computer-readable recording medium may record a specific program that defines a control command for a context awareness service in response to a user's input, executes a particular action when any audio corresponding to a control command is received through the microphone, and processes the output of context information corresponding to the executed action.

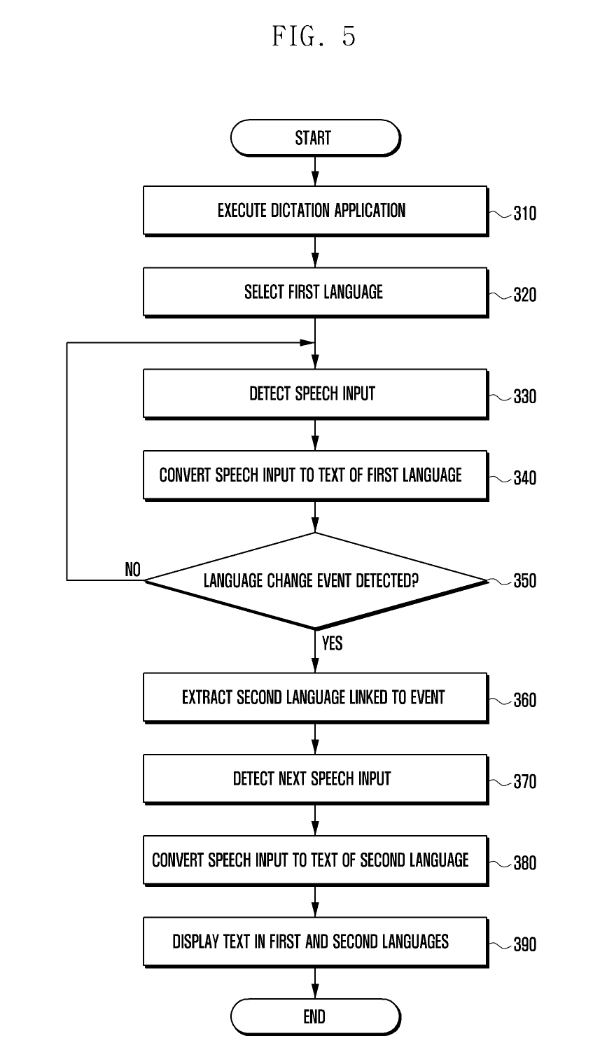

FIG. 5 is a flow diagram illustrating a method for controlling a function of dictation based on speech recognition, in accordance with an embodiment of the present invention.

Referring to FIG. 5, the control unit 200 executes a dictation application, in step 310. The dictation application may be executed in response to a user's menu manipulation or a detection of predefined or user-defined context.

When the dictation application is running, the control unit 200 selects the first language, in step 320. For example, the control unit 200 may select a predefined or user-defined default language as the first language.

The control unit 200 detects a speech input entered into the electronic device, in step 330. For example, a user's utterance entered through the microphone of the electronic device may be converted into a digital signal.

In step 340, the control unit 200 converts the detected speech input into text of the first language, and stores the text of the first language in the memory unit 180. A user's utterance entered into the electronic device is based on the first language. If a user desires to enter his or her utterance based on a language different from the first language, a language change event is required as described with respect to 350.

The control unit 200 may display the stored text of the first language on the display, in step 340, or after a speech input is completed.

In step 350, the control unit 200 determines whether a language change event is detected. The control unit 200 may detect a language change event through at least one of a sensor, a camera, a soft key, a hard key, a stylus pen, or a combination thereof

The sensor may use at least one of a motion sensor, such as an acceleration sensor, a gyro sensor, a geomagnetic sensor, an inertial sensor, or a tilt sensor, an infrared sensor, a blow sensor, and a touch sensor.

For example, the control unit 200 may detect a language change event through the motion sensor that detects variations of angle, direction, posture, position, motion intensity, and/or velocity in the electronic device.

Alternatively or additionally, the control unit 200 may detect a language change event by analyzing an image obtained through the camera and comparing the analyzed image with a stored image in order to find an identical image.

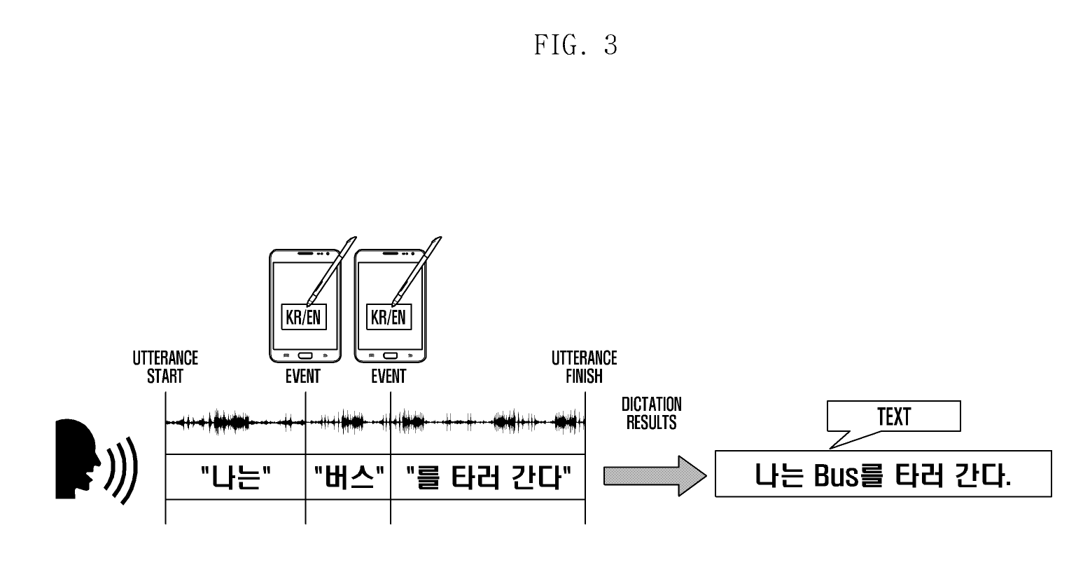

Alternatively or additionally, as shown in FIG. 3, the control unit 200 may detect a language change event from a touch or press on a soft key for toggle between two types of language displayed on the touch screen. This soft key is a menu button for selecting one language type from two or more types of available languages.

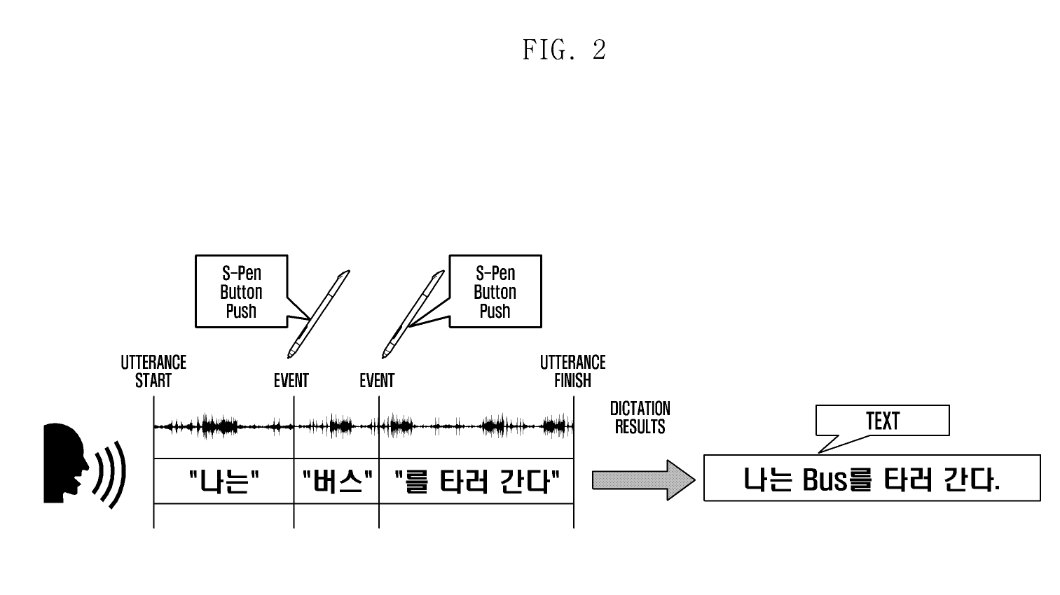

Alternatively or additionally, as shown in FIG. 2, the control unit 200 may detect a language change event by detecting a push event from a key button of the stylus pen. In this case, all types of available languages may be linked to the key button of the stylus pen. Namely, whenever the key button of the stylus pen is pressed, one of the available language types is selected by turns. Alternatively or additionally, a hard key button equipped in the electronic device may be used in a similar manner.

Alternatively or additionally, the control unit 200 may detect a language change event by detecting at least one of a specific character, a specific symbol, a specific number, and a specific sound, which are entered by a user.

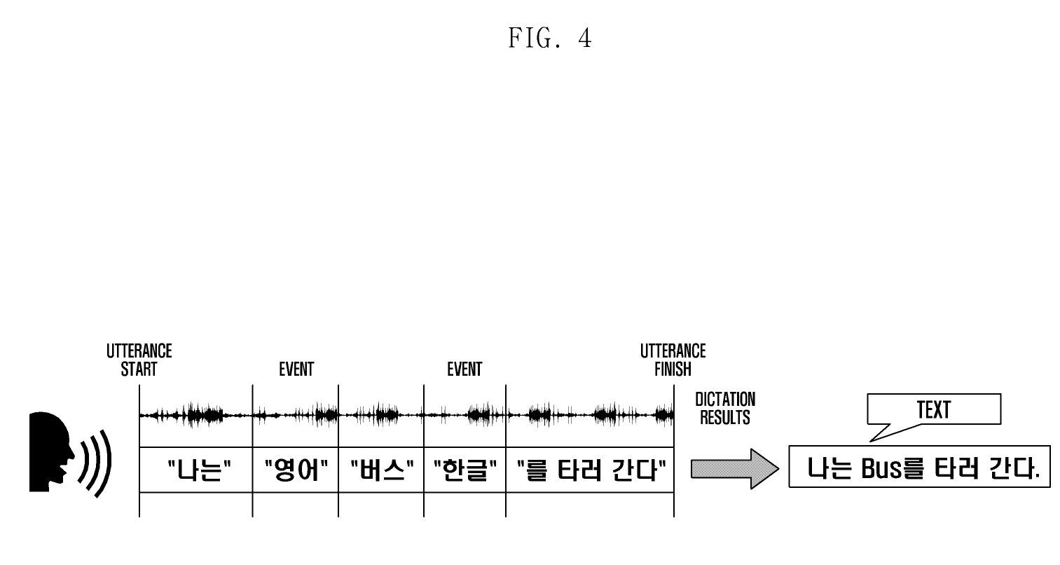

For example, as shown in FIG. 4, a user may speak “ [symbol] ” (that means “I”) in the Korean language (the first language), and further speak a specific word “ [symbol] ” (that means “English”) in the Korean language. Since the specific word “ [symbol] ” is linked in advance to the English language as the second language, the control unit 200 changes the Korean language, which is the first language, to the English language, which is the second language. Thereafter, when a user speaks “ [symbol] ” (that means “bus”) in the Korean language, the control unit 200 displays an English word “BUS” on the display unit. Next, if a user speaks a specific word “ [symbol] ” (that means “Korean language”) in the Korean language, the control unit 200 changes again from the second language to the first language since the specific word “ [symbol] ” is linked in advance to the Korean language as the first language. Therefore, the next word is displayed in the Korean language on the display unit.

When a language change event is not detected in step 350, the control unit continues to detect speech input, in step 330. When a language change event is detected, the control unit 200 extracts the second language linked to a language change event, in step 360. Specifically, the control unit 200 may analyze the detected language change event and thereby find the second language linked to the language change event.

The second language may be a specific language type linked to a specific language change event among a plurality of language types stored previously in the electronic device. Such a link (i.e., a mapping relation) between a specific language change event and a specific language type may be initially created by a designer of the electronic device and varied or set by a user.

The control unit 200 detects a next speech input entered into the electronic device, in step 370.

In step 380, the control unit 200 converts the detected speech input into text of the second language, and stores the text of the second language in the memory unit. A user's utterance entered into the electronic device is associated with the second language. If a user desires to enter his or her utterance associated with any other language different from the second language into the electronic device, another language change event is required, as described above with respect to step 350.

In step 390, the control unit 200 displays the stored text of the second language on the display unit. If the text of the first language is not displayed in step 340, the text of the first language may be displayed on the display unit together with the text of the second language.

In an embodiment of the present invention, the text of the first language and the text of the second language may be displayed differently with different colors and/or different fonts.

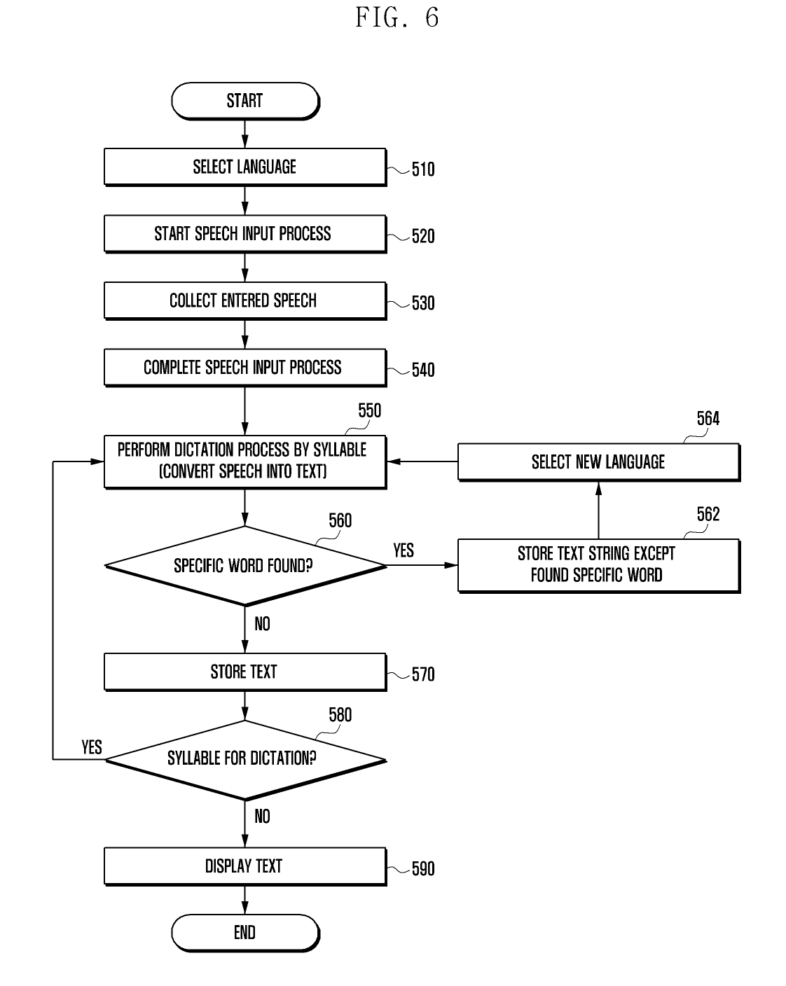

FIG. 6 is a flow diagram illustrating a method for controlling a function of dictation based on speech recognition, in accordance with another embodiment of the present invention.

Referring to FIG. 6, the control unit 200 selects a language, in step 510. Specifically, the control unit 200 may select a predefined or user-defined default language as the language.

The control unit 200 begins a speech input process, in step 520, collects entered speech, in step 530, and completes the speech input process, in step 540. The speech input process may be forcedly finished by a user or automatically finished when no speech is entered for a given time.

The control unit 200 performs a dictation process regarding the collected speech by syllable, in step 550. Specifically, the control unit 200 converts recognized speech into a text string, and displays the text string on the display unit.

In step 560, it is determined whether a specific word is found. If the control unit 200 finds a specific word, the control unit 200 stores a text string except the specific word, in step 562, and also selects a new language corresponding to the specific word, in step 564. Based on the new language, the control unit 200 performs a dictation process by syllable, in step 550.

The control unit 200 may find a predefined specific word during a dictation process for converting speech into text and displaying a text string. The control unit 200 may extract another language corresponding to the found specific word, and based on the extracted language, may continue to perform a dictation process.

If no specific word is found in step 560, the control unit 200 stores a text string converted from a speech input, in step 570.

The control unit 200 determines whether there is any syllable for dictation, in step 580. If there is no syllable for dictation, the control unit 200 displays the stored text string on the display unit, in step 590. If there is a syllable for dictation, the control unit 200 performs a dictation process by syllable, in step 550.

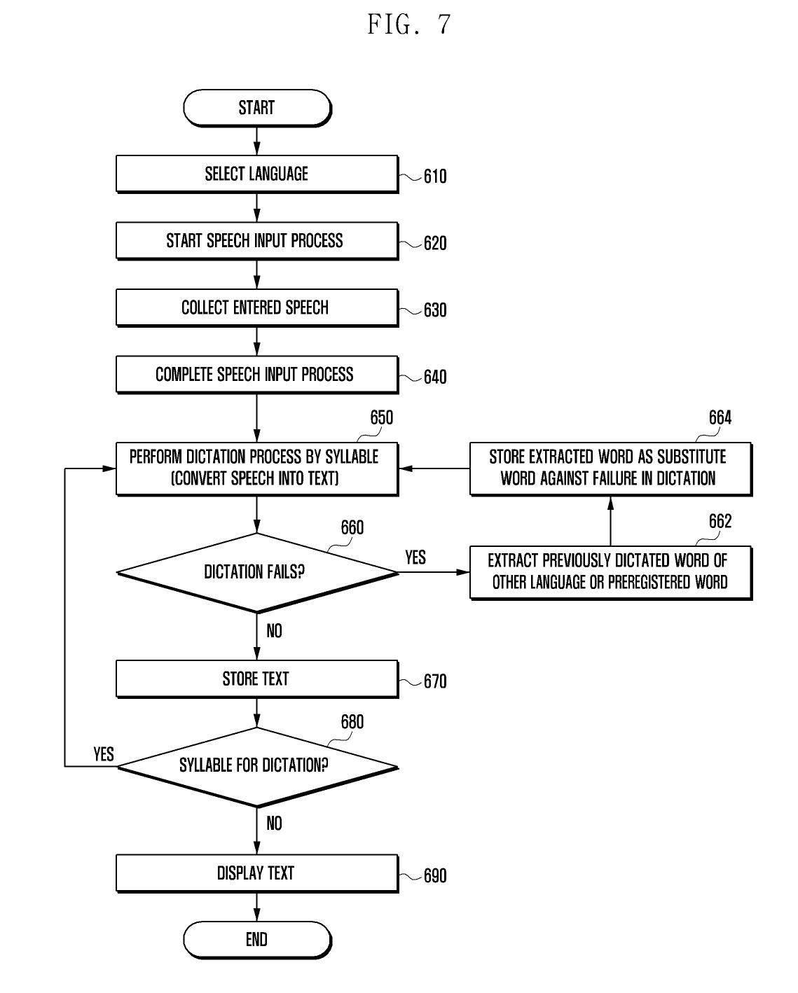

FIG. 7 is a flow diagram illustrating a method for controlling a function of dictation based on speech recognition, in accordance with another embodiment of the present invention.

Referring to FIG. 7, the control unit 200 selects a language, in step 610. Specifically, the control unit 200 may select a predefined or user-defined default language as the language.

The control unit 200 begins a speech input process, in step 620, collects entered speech, in step 630, and completes the speech input process, in step 640. The speech input process may be forcedly finished by a user or automatically finished when no speech is entered for a given time.

The control unit 200 perform a dictation process regarding the collected speech by syllable, in step 650. Specifically, the control unit 200 may convert recognized speech into a text string, and display the text string on the display unit.

In step 660, the control unit 200 determines whether a dictation process fails. When the dictation process fails, the control unit 200 extracts a previously dictated word of another language or a preregistered word, in step 662. The control unit 200 stores the extracted word as a substitute word for a failure in dictation, in step 664, and performs a dictation process regarding the extracted word by syllable, in step 650.

If any error or failure happens in a dictation process, the control unit 200 may extract a previously dictated same or similar word of another language or a specific word preregistered for error or failure, and may continue to perform a dictation process regarding the extracted word by syllable.

If dictation does not fail in step 660, the control unit 200 stores a text string converted from a speech input, in step 670.

The control unit 200 determines whether there is any syllable for dictation, in step 680. If there is no syllable for dictation, the control unit 200 displays the stored text string on the display unit, in step 690. If there is a syllable for dictation, the control unit 200 performs a dictation process, in step 650.

The above-discussed methods for a dictation function control in various embodiments may be used alone or in combination.

As described above, the function control method and apparatus based on speech recognition may enhance the usability of an Input Method Editor (IME) that provides a dictation function based on a speech input, by enabling an easy change of a language type in dictation of a sentence using speech recognition.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method for controlling a function based on speech recognition, the method comprising the steps of:
recognizing speech input in a first language;
performing dictation, which converts the speech input into text based on the first language;
detecting a language change event;
recognizing additional speech input in a second language, which is different from the first language, after the language change event; and
performing dictation, which converts the additional speech input into additional text based on the second language.

2. The method of claim 1, wherein detecting the language change event comprises detecting the language change event using at least one of a sensor, a camera, a soft key, a hard key, a stylus pen, and a combination thereof

3. The method of claim 2, wherein the language change event is detected through the sensor that detects variations of angle, direction, posture, position, motion intensity, and velocity in an electronic device.

4. The method of claim 2, wherein the sensor comprises at least one of an acceleration sensor, a gyro sensor, a geomagnetic sensor, an inertial sensor, a tilt sensor, an infrared sensor, a blow sensor, and a touch sensor.

5. The method of claim 2, wherein detecting of the language change event comprises:
analyzing an image obtained through the camera;
comparing the analyzed image with a stored image; and
extracting a language type linked to the stored image, when the analyzed image is substantially identical to the stored image.

6. The method of claim 2, wherein detecting the language change event comprises:
displaying a plurality of language types on the soft key; and
detecting a language type by a touch or press on the soft key.

7. The method of claim 2, wherein detecting of the language change event comprises:
detecting a push event from the hard key or a key button of the stylus pen; and
extracting a language type linked to the push event.

8. The method of claim 7, wherein all types of available languages are linked to the hard key or the key button of the stylus pen, and whenever the hard key or the key button is pressed, one of the available language types is selected in turn.

9. The method of claim 2, wherein detecting the language change event comprises:
detecting at least one of a specific character, a specific symbol, a specific number, a specific sound, and a specific voice; and
extracting a language type linked to the detected at least one of the specific character, the specific symbol, the specific number, the specific sound, and the specific voice.

10. The method of claim 1, wherein recognizing the speech input comprises:
analyzing the speech input; and
extracting a language type based on the analyzed speech input from two or more stored language types.

11. The method of claim 10, wherein performing dictation based on the first language comprises:
converting the speech input into a text string based on a language of the extracted language type; and
displaying the text string.

12. The method of claim 1, wherein detecting the language change event comprises:
analyzing the language change event; and
extracting a language type based on the analyzed language change event from two or more stored language types.

13. The method of claim 12, wherein performing dictation based on the second language includes:
converting the additional speech input into a text string based on a language of the extracted language type; and
displaying the text string.

14. An apparatus for controlling a function based on speech recognition, the apparatus comprising:
a speech input unit configured to recognize speech input, and to recognize additional speech input after a language change event for changing from a first language to a second language, which is different from the first language;
a control unit configured to perform dictation, which converts the speech input into text based on the first language, and to perform dictation, which converts the additional speech input into additional text based on the second language; and
a display unit configured to display the text based on the first language and to display the additional text based on the second language.

15. The apparatus of claim 14, further comprising:
at least one of an acceleration sensor, a gyro sensor, a geomagnetic sensor, an inertial sensor, a tilt sensor, an infrared sensor, a blow sensor, a touch sensor, a camera, a soft key, a hard key, and a stylus pen, each of which is configured to detect the language change event.

16. The apparatus of claim 14, wherein the control unit is further configured to control the display unit to display the text based on the first language and the additional text based on the second language differently by means of at least one of different colors and different fonts.
